(19) United States
(12) Patent Application Publication
(10) Pub. No.: US 2008/0195513 A1
(43) Pub. Date: Aug. 14, 2008

(54) Method and apparatus for embedded copy tracking with deferred remote billing

(75) Inventors: Michael Cahill, San Rafael, CA (US); Jeremy Evans, Lafayette, CA (US); Dmytri Bazulin, Prevost (CA); Raymond Bradley, Walnut Creek, CA (US)

Correspondence Address: Daniel L. Dawes;Myers Dawes Andras & Sherman LLP, Suite 1150, 19900 MacArthur Blvd., Irvine, CA, 92612, US

(73) Assignee: Sepialine, Inc., San Francisco, CA (US)

(21) Appl. No.: 11/706,704

(22) Filed: Feb. 14, 2007

(51) Int. Cl. G06Q 99/00; G06F 3/00

(52) U.S. Cl. 705/34; 715/700

(57) ABSTRACT

A method of accounting for job activity in a multifunctional device comprises the steps of: providing user identification information associated with use of the multifunctional device; performing a job through use of the multifunctional device without providing any billing information relating to the job; communicating unbilled job information to at least one remote user location associated with the user identification information, the unbilled job information relating to the performed job completed with the use of the multifunctional device and communicated through a computer network without employing any hardware modification of the multifunctional device; and inputting billing data relating to the unbilled job information at the least one remote user location.

### BACKGROUND OF THE INVENTION

1. Field of the Invention

The invention relates to the field of apparatus and methods for tracking activity and costs on copiers and multi-function printers (MFPs)

2. Description of the Prior Art

Cost recovery software captures office expenses, such as print, copy, scan and fax activity. In a typical conventional two-phase, asynchronous print tracking system, an office job is sent from a client computer to a server computer, where its existence is detected, and where data about the job is extracted. The extracted data is sent to a central message queue, where the client computer reads the data and graphically notifies the user of the existence of unbilled job activity. Billed job information is preferably written to a central location, where a management interface allows for viewing and reporting of job data.

As described in U.S. Patent Application 2002/0113995, incorporated herein by reference, an office expense is tracked at the point on the computer or communication network where it occurs, such as a print server, copy machine, fax machine, etc. Using an asynchronous transport mechanism, data about the expense item is routed to the desktop of the user responsible for accounting or controlling the use or cost. Based on rules established in the software, the user is then prompted to allocate the expense to an accounting code, such as a project, client, department, etc.

An MFP is a unit of office equipment that functions as a photocopier, a networked printer, a fax machine and/or a scanner. It must be understood that any kind of equipment or job function is equivalently included, e.g. telephones, communications equipment, display, or information storage equipment without limitation. Although commonly referred to as “copiers,” MFPs are distinguished from traditional copiers by the variety of tasks they perform. Increasingly, MFP manufacturers (e.g. Canon, Ricoh, Konica-Minolta, Toshiba) are adding capabilities to their MFP products that allow third-party developers to embed and run the third-party software directly on-board the MFP.

MFP front panels usually resemble traditional copiers with a numeric keypad, a green “copy” button, and other items. In addition, most MFPs include a small computer-like screen as depicted in FIG. 1. It is on this screen that third-party software routines run or are displayed.

Prior to the advent of embedded software capability on MFPs 10 as shown on FIG. 1, the only way to track user activity on such a device for accounting purposes was to wire a hardware device into the accounting harness of the MFP 10. The accounting harness allows a developer to:
a. Control access to the device (lock and unlock)
b. Receive feedback as to the number of pages produced (count “clicks”)

Third party cost recovery vendors have historically produced hardware/software combinations to interact with the accounting harness and report back to a central database residing on a server.

Tracking MFP copy activity through the accounting harness is relatively costly, difficult and unsightly, as additional hardware must be purchased. Moreover, most accounting harnesses provide only minimal feedback and are often difficult to configure properly, sometimes requiring special engineering knowledge

Embedded MFP software allows cost recovery vendors to eliminate hardware and still provide cost accounting (“pure-software” tracking). This results in cost savings to customers and eliminates the need to install and house unsightly hardware components.

In order for pure-software tracking to be employed, the target MFP 10 must first provide the following:
a. A mechanism (“API”) for third-party vendors to develop and deploy proprietary software to the MFP. Most likely this software will run on the screen portion of the MFP front panel.
b. A way for said third-party software to sufficiently conceal, disable or otherwise restrict user access to the MFP.
c. Feedback to the third-party software during a copy operation, so that third-party software can count pages. Depending on the sophistication of the MFP 10, additional feedback information may also be recorded (e.g. color vs. black/white, duplex vs. single-sided pages, etc.). Feedback may be provided by the same API described in paragraph “a,” above, via a separate API, or via the harness described above.

Most cost recovery vendors employ the same basic workflow in order to capture MFP activity: The conventional steps typically are:
a. User logs in. This can be via network username/password pair, or via a numeric code.
b. User provides first-tier billing code (e.g. project, client, etc.)
c. User provides second-tier billing code (e.g. phase, matter, etc.)
d. User provides additional metadata (billable/non-billable, reason, etc.)
e. Copier is unlocked
f. User performs copy activity
g. User logs out explicitly, or is automatically logged out after a predetermined period of inactivity. Copier is locked.
h. Copy tracking hardware and/or software records copy job, consisting of user identification, billing information and metadata, and page count.

The prior art employs a “pre-billed” model, in which the user is expected to supply all accounting information (e.g. project/phase, client/matter, billable/non-billable) prior to performing work at the copier. Accounting questions are mandatory and responses must be valid in order to proceed. If the customer desires additional accounting information (department, overhead code, task number, etc.), then additional prompts are required.

Most prior art offers no mechanism for searching through lists of billing codes (project, client, etc), leaving the end user to memorize what are often lengthy numeric codes. Rather than helping the user through the process, most of the prior art simply notifies the user when responses are invalid with a prominent screen notice.

The pre-billed model found in prior art requires all accounting data is entered by the user before the MFP is unlocked. This model is self-enforcing in that users must respond to all questions (possibly inaccurately) in order to gain access to the MFP. Failure to respond to prompts, or failure to supply valid responses to prompts, results in denial of access to the equipment.

Cost recovery that employs the traditional workflow described above is highly unpopular. The number of mandatory steps, coupled with the absence of a search mechanism, frustrates end users. Many companies employ an “administrator override” billing code (e.g. “99999”). These override codes often become common knowledge, and users eventually use it in lieu of the correct billing code in order to avoid frustration and lost productivity.

### BRIEF SUMMARY OF THE INVENTION

The illustrated embodiment of the invention is a method of accounting for job activity in a multifunctional device comprising the steps of: providing user identification information associated with use of the multifunctional device; performing a job through use of the multifunctional device without providing any billing information relating to the job; communicating unbilled job information to at least one remote user location associated with the user identification information, the unbilled job information relating to the performed job completed with the use of the multifunctional device and communicated through a computer network without employing any hardware modification of the multifunctional device; and inputting billing data relating to the unbilled job information at the least one remote user location.

The step of providing user identification information comprises the step of providing a network username/password pair, or a numeric code.

The step of providing user identification information further comprising the step of unlocking access to the multifunctional device and where the step of performing a job through use of the multifunctional device further comprises the step of logging out of the multifunctional device and locking access to the multifunctional device.

The step of inputting billing data relating to the unbilled job information at the least one remote user location comprises the step of inputting billing data into a single input screen.

The step of inputting billing data relating to the unbilled job information at the least one remote user location comprises the step of inputting billing data in parallel into a plurality of data input windows.

The step of inputting billing data relating to the unbilled job information at the least one remote user location comprises the step of inputting billing data into an input screen which is arranged and configured in at least one configuration according to administrator or user choice.

The step of inputting billing data in parallel into a plurality of data input windows comprises the step of inputting billing data in at least one input window is a drop-down window with a predetermined list of possible input entries.

The step of inputting billing data into an input screen which is arranged and configured in at least one configuration according to administrator or user choice comprises the step of selecting which data prompts are visible, which data prompts are required, what are acceptable values for each prompt, and/or what the name of the prompt is.

The step of inputting billing data relating to the unbilled job information at the least one remote user location comprises the step of inputting billing data for multiple activity types in a single user interface.

The step of inputting billing data in at least one input window which is a drop-down list with a predetermined list of possible input entries comprises the step of auto-complete searching the predetermined list of possible input entries.

The step of inputting billing data in at least one input window comprises the step of establishing administrator-set quotas.

The step of inputting billing data in at least one input window comprises the step of displaying a graphical icon in an unobtrusive location when a given user's unbilled activity count is below quota.

The step of inputting billing data relating to the unbilled job information in at least one remote user location comprises the step of displaying an input billing data screen topmost on the least one remote user location. The input billing data screen is displayed when the user's unbilled activity count meets or exceeds quota.

The step of inputting billing data relating to the unbilled job information in at least one remote user location comprises the step of displaying an immovable and unremovable input billing data screen in the center of or at least in a materially obstructive position on the computer screen.

The illustrated embodiment of the invention also comprises an apparatus or software controlled computer network for performing each of the various embodiments of the method of the invention.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

FIG. 1 is a depiction of the input screen and panel of a multifunctional printer or device of the prior art with which the invention is employed.

FIG. 2 is a block diagram of a computer network in which the method of the invention is employed.

FIG. 3 is a graphic table illustrating the steps and screen displays employed when an embodiment of the method of the invention is performed.

FIG. 4 is the data billing client (DBC) screen display of the user's computer in one embodiment of the invention.

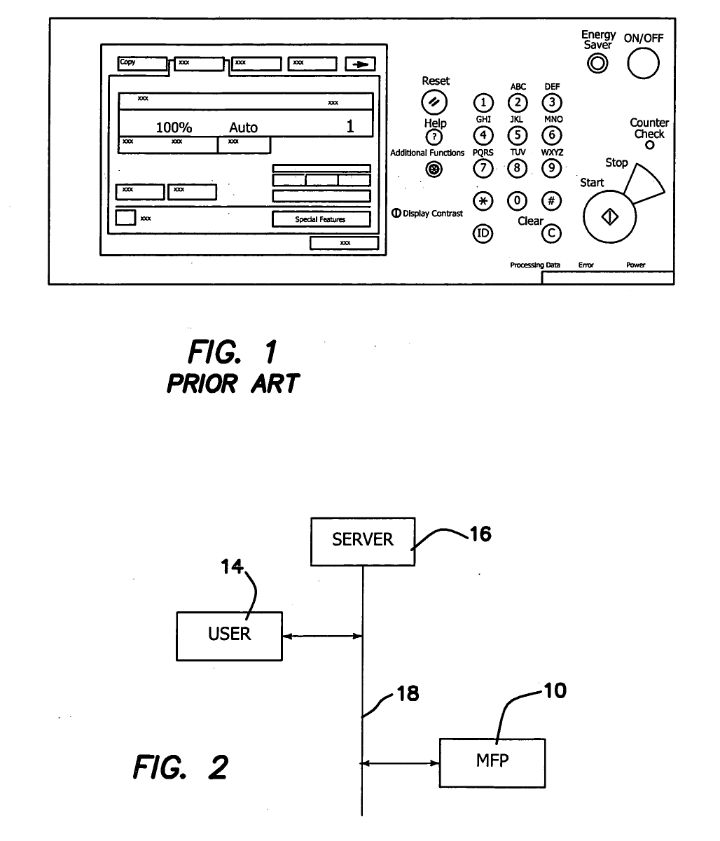

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

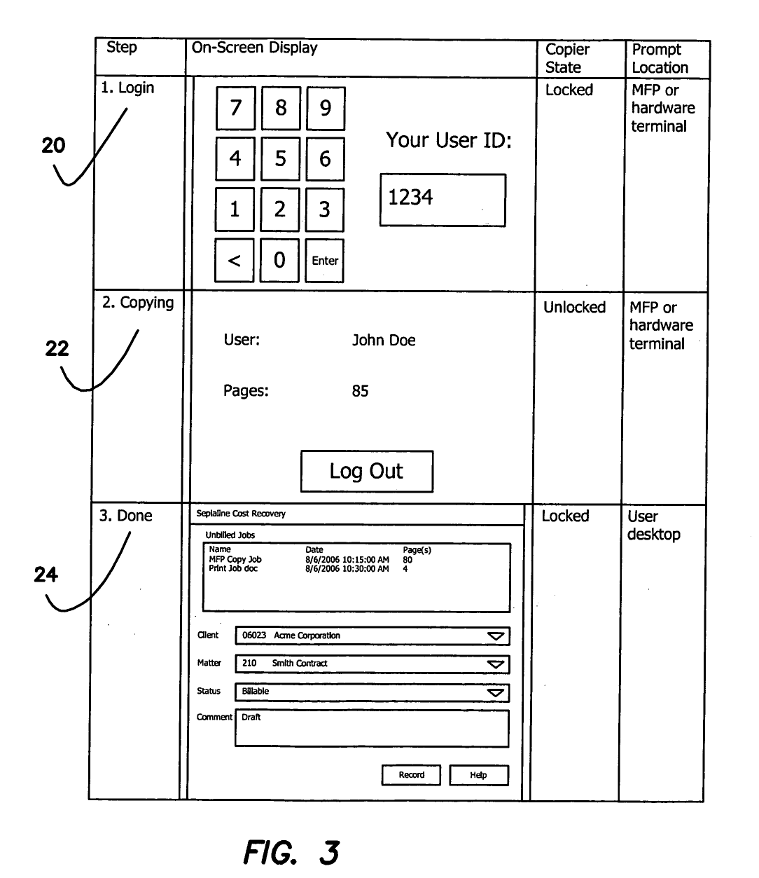

The illustrated embodiment a fundamentally different workflow from that described in the prior art. For example, the method of the illustrated embodiment comprises the steps of:
a. At step 20 in FIG. 3 a user logs into server 16 via network 18 as depicted in the block diagram of FIG. 2. This can be via network username/password pair, or via a numeric code.
b. The copier or MFP 10 is unlocked.
c. At step 22 in FIG. 3 the user performs copy or job activity at MFP 10 controlling the job functions according to the device protocols.
d. The user logs out explicitly on site, or is automatically logged out after a predetermined period of inactivity. Copier or MFP 10 is locked.
e. At step 24 of FIG. 3 information about the unbilled MFP activity (e.g. user ID, equipment ID, page count) is routed to the responsible user's desktop 14 via a message queue in server 16 as described in U.S. Patent Application 2002/0113995.
f. Upon returning to his desktop computer 14, the user is presented with a billing interface in step 24, in which he or she provides accounting information in one or more input fields on a single screen. Additional or fewer input screens or drop down input lists and fields could be included, if needed.

Hence, the illustrated embodiment of the invention is described as “embedded copy tracking with deferred remote billing.” The illustrated embodiment is best understood by comparison with the traditional prior method as summarized in Table 1.

TABLE 1

| Traditional | Illustrated Embodiment |
|---|---|
| User logs in. This can be via network | User logs in. This can be via |
| username/password pair, or via a | network username/password |
| numeric code. | pair, or via a numeric code. |
| User provides first-tier billing code (e.g. | |
| project, client, etc.) | |
| User provides second-tier billing code | |
| (e.g. phase, matter, etc.) | |
| User provides additional metadata | |
| (billable/non-billable, reason, etc.) | |
| Copier is unlocked | Copier is unlocked |
| User performs copy activity | User performs copy activity |
| User logs out explicitly, or is | User logs out explicitly, or is |
| automatically logged out after a | automatically logged out after a |
| predetermined period of inactivity. | predetermined period of |
| Copier is locked. | inactivity. Copier is locked. |
| Copy tracking hardware and/or | Upon returning to his desktop |
| software records copy job, consisting of | computer, user is presented |
| user identification, billing information | with a billing interface, in which |
| and metadata, and page count | he provides accounting |
| | information in a single screen |

In contrast to the “hostage” and “quarantine” enforcement methods described above, the present invention is employed in the system of U.S. Patent Application 2002/0113995, which may be termed a “nag” enforcement method. This enforcement method allows the job to pass unhindered from the client computer to the server, and then to the device where the job is performed.

A quota, defined by a system administrator, determines how many unbilled jobs can exist for a given user before a mandatory billing interface is displayed. While a given user's unbilled job count is below the quota, the user may recall the billing interface at his or her discretion. The user may thus delay the entry of the required billing information to a convenient time, but cannot avoid entering the information and cannot indefinitely delay the entry of the information to a point where the user may no longer recall the pertinent information. Enforcement is preferably accomplished once the quota is reached by obscuring the computer screen with the billing interface, which cannot be removed or moved. Though other processes on the client computer are not interrupted, the user is essentially unable to use the computer without sufficiently addressing, then dismissing, the billing interface.

Many of the advantages flow from the separation of detection (phase 1) and billing (phase 2) of print activity, and the use of a quota-based message queue between the separate phases. The “nag” system allows native print processes to flow undisturbed by the requirement to enter billing information. Decoupling detection and billing eliminates onerous enforcement techniques typical of the prior art. It should be noted that in the asynchronous embodiment, the act of writing data about a job to a database preferably takes place when the billing data is supplied; this contrasts with some systems in which the writing of data may or may not occur at or near the time when the job information is extracted and stored. In the asynchronous model, the moment that the factual information concerning a job is extracted it is recorded in a message queue. The user is then prompted to supply additional billing information.

The nag system is based on the view that job should remain a native process, and takes a “hands-off-the-job-process” approach that makes few if any modifications to the process of performing the job. Thus at the core of the system is an intention to impose the fewest restrictions upon users while maintaining a reliable record of job events for cost allocation and recoupment.

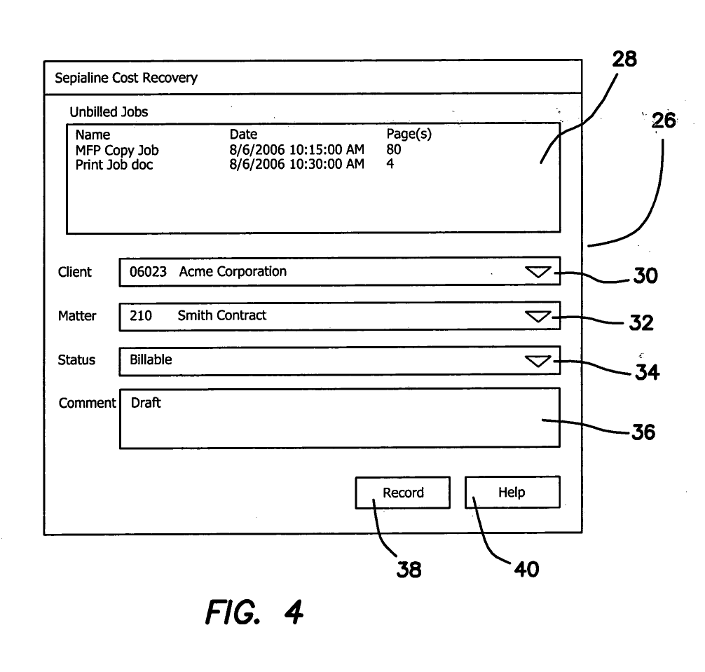

Consider now the user interface at the desktop 14. When a user logs in at step 20 in FIG. 3, that user becomes identified on the computer network 18. A Desktop Billing Client (DBC) 26 as shown in FIG. 4 is displayed on the screen or display of the computer(s) 14 where the identified user is logged in. DBC 26 is generated by software resident on user computer 14 and is controlled by client billing software modules in server 16 where a cost accounting database is being assembled as described in greater detail in U.S. Patent Application 2002/0113995. The DBC 26 prompts the user to supply accounting information as defined by a system administrator. Unlike the prior art workflow, described above, in which accounting data is entered serially through a sequence of on-screen pages at the MFP, the DBC 26 prompts for all required values in parallel as depicted in the screen display of FIG. 2. In other words, the billing data may be input, corrected and re-input in any order into the windows 30-36 in any order. In the illustrated embodiment unbilled jobs appear in window 28 as collected by server 16 for user desktop 14. The client or job to be billed is entered by the user into window 30, the matter or sub-job to be billed in window 32, the status of the billed charged into window 34 and other comments into window 36. Windows 30-34 are drop down windows as indicated by the down arrow in the right end of the window so that only approved inputs are possible for input. When all the data is entered and deemed correct by the user, the record button 38 is clicked. A help button 40 is provided for assistance whenever needed. It must be understood that the DBC 26 of FIG. 3 is illustrative only and that many other arrangements and inputs could be provided without departing from the scope of the invention.

The various prompts on the DBC 26 are configured by an administrator. Configurable elements illustratively include:
a. Which data prompts are visible?
b. Which data prompts are required?
c. What are acceptable values for each prompt?
d. What is the name of the prompt (e.g. “Client/Matter”, “Project/Phase”)

The illustrated embodiment of the invention allows the end user to provide accounting data for a variety of different types of activity. DBC 26 can be arranged and configured by the administrator in a wide variety of ways to meet the accounting needs of the specific situation, including having a different configuration and/or inputs possible for different clients and matters. FIG. 4, for example, illustrates the DBC 26 prompting the user to account for both an MFP copy job of 80 pages and a subsequent computer print job of 4 pages. The DBC 26 can prompt users from a variety of activities, including:

a. Print

b. Copy

c. Scan

d. Fax

e. Three-dimensional printers

f. Laser cutters

g. Telephone calls

h. Computer disk drive storage

i. Employee time

This list is not exhaustive and may be arbitrarily altered or expanded to meet the needs of the user's situation, not only in an office, but in any type of setting including order fulfillment, warehousing, manufacturing, routing and other job situations without limitation. No other prior art system supports multiple activity types in a single user interface.

Certain required information (e.g. billing codes, sub-codes, status) are displayed to the user as “dropdown lists” on windows 30-34. A dropdown list is a user interface element found in computer software that eliminates the possibility of selecting an item not in a predefined list. Hence, unlike the scenario, where a user has supplied an invalid response and receives only a prominent screen notice of invalid entry, the DBC 26 does not allow the user into such a state.

Further, the primary billing code dropdown list in the DBC 26 implements an “auto-complete” search. In this mechanism, a user is permitted to type letters or numbers into the user interface, and the dropdown list nearly instantly locates the first item matching the typed letters.

Because the present invention does not require accounting data beforehand, but rather allows users to perform work on the MFP 10 with only one piece of information (a user login), some other enforcement mechanism must be provided to insure proper accounting data input. The DBC 26 enforces the accounting rules at the user's desktop computer 14 by remaining topmost, meaning that it conceals some or all of any other software applications running on the screen. The DBC 26 obscures a sufficient amount of the computer desktop screen to impede use of the computer 14 without first responding to the required prompts of the DBC 26. Further, the DBC software window cannot be moved to a different location on the screen, closed or dismissed.

The ability to control MFP access through a single prompt (user ID) and then complete accounting at the user's desktop or from another computer coupled to the network is not available from any known system.

The illustrated embodiment of the invention significantly improves on the prior art by introducing a system that minimizes memorization and user intervention at the point of work, leading to a smoother workflow and a more user friendly experience. Subsequently, accountability is maintained through a desktop component that at once enforces the system and also prompts the user for required information in parallel.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

We claim:

1. A method of accounting for job activity in a multifunctional device comprising:
providing user identification information associated with use of the multifunctional device;
performing a job through use of the multifunctional device without providing any billing information relating to the job;
communicating unbilled job information to at least one remote user location associated with the user identification information, the unbilled job information relating to the performed job completed with the use of the multifunctional device and communicated through a computer network without employing any hardware modification of the multifunctional device; and
inputting billing data relating to the unbilled job information at the least one remote user location.

2. The method of claim 1 where providing user identification information comprises providing a network username/password pair, or a numeric code.

3. The method of claim 1 where providing user identification information further comprising unlocking access to the multifunctional device and where performing a job through use of the multifunctional device further comprises logging out of the multifunctional device and locking access to the multifunctional device.

4. The method of claim 1 where inputting billing data relating to the unbilled job information at the least one remote user location comprises inputting billing data into a single input screen.

5. The method of claim 1 where inputting billing data relating to the unbilled job information at the least one remote user location comprises inputting billing data in parallel into one or a plurality of data input windows.

6. The method of claim 1 where inputting billing data relating to the unbilled job information at the least one remote user location comprises inputting billing data into an input screen which is arranged and configured in at least one configuration according to administrator or user choice.

7. The method of claim 5 where inputting billing data in parallel into a plurality of data input windows comprises inputting billing data in at least one input window which is a drop-down window with a predetermined list of possible input entries.

8. The method of claim 7 where inputting billing data into an input screen which is arranged and configured in at least one configuration according to administrator or user choice comprises selecting which data prompts are visible, which data prompts are required, what are acceptable values for each prompt, and/or what the name of the prompt is.

9. The method of claim 1 inputting billing data relating to the unbilled job information at the least one remote user location comprises inputting billing data for multiple activity types in a single user interface.

10. The method of claim 7 where inputting billing data in at least one input window is a drop-down window with a predetermined list of possible input entries comprises auto-complete searching the predetermined list of possible input entries.

11. The method of claim 1 where inputting billing data relating to the unbilled job information at the least one remote user location comprises displaying an input billing data screen topmost on the least one remote user location.

12. The method of claim 1 where inputting billing data in at least one input window comprises displaying a graphical icon in an unobtrusive location when a user's unbilled activity count is below quota and displaying an input billing data screen topmost when the user's unbilled activity count meets or exceeds quota.

13. The method of claim 12 where displaying an input billing data screen topmost comprises displaying an immovable and unremovable input billing data screen topmost.

14. An apparatus of accounting for job activity in a multifunctional device comprising:
means for providing user identification information associated with use of the multifunctional device;
means for performing a job through use of the multifunctional device without providing any billing information relating to the job;
means for communicating unbilled job information to at least one remote user location associated with the user identification information, the unbilled job information relating to the performed job completed with the use of the multifunctional device and communicated through a computer network without employing any hardware modification of the multifunctional device; and
means for inputting billing data relating to the unbilled job information at the least one remote user location.

15. The apparatus of claim 14 where the means for providing user identification information comprises means for providing a network username/password pair, or a numeric code.

16. The apparatus of claim 14 where the means for providing user identification information further comprising means for unlocking access to the multifunctional device and where the means for performing a job through use of the multifunctional device further comprises means for logging out of the multifunctional device and locking access to the multifunctional device.

17. The apparatus of claim 14 where the means for inputting billing data relating to the unbilled job information at the least one remote user location comprises means for inputting billing data into a single input screen.

18. The apparatus of claim 14 where the means for inputting billing data relating to the unbilled job information at the least one remote user location comprises means for inputting billing data in parallel into a plurality of data input windows.

19. The apparatus of claim 14 where the means for inputting billing data relating to the unbilled job information at the least one remote user location comprises means for inputting billing data into an input screen which is arranged and configured in at least one configuration according to administrator or user choice.

20. The apparatus of claim 18 where the means for inputting billing data in parallel into a plurality of data input windows comprises means for inputting billing data in at least one input window is a drop-down window with a predetermined list of possible input entries.

21. The apparatus of claim 20 where the means for inputting billing data into an input screen which is arranged and configured in at least one configuration according to administrator or user choice comprises means for selecting which data prompts are visible, which data prompts are required, what are acceptable values for each prompt, and/or what the name of the prompt is.

22. The apparatus of claim 14 where the means for inputting billing data relating to the unbilled job information at the least one remote user location comprises means for inputting billing data for multiple activity types in a single user interface.

23. The apparatus of claim 20 where the means for inputting billing data in at least one input window is a drop-down window with a predetermined list of possible input entries comprises means for auto-complete searching the predetermined list of possible input entries.

24. The apparatus of claim 14 where the means for inputting billing data relating to the unbilled job information at the least one remote user location comprises means for displaying an input billing data screen topmost on the least one remote user location.

25. The apparatus of claim 14 where the means for inputting billing data in at least one input window comprises means for displaying a graphical icon in an unobtrusive location when a user's unbilled activity count is below quota and for displaying an input billing data screen topmost when the user's unbilled activity count meets or exceeds quota.

26. The apparatus of claim 25 where the means displaying an input billing data screen topmost comprises means for displaying an immovable and unremovable input billing data screen topmost.
